(19) United States
(12) Patent Application Publication
(10) Pub. No.: US 2021/0217114 A1
(43) Pub. Date: Jul. 15, 2021

(54) HOUSE STATUS AND ANALYSIS

(71) Applicant: Wells Fargo Bank, N.A., San Francisco, CA (US)

(72) Inventors: Abraham Drucker, San Fransisco, CA (US); Allen R. Blatter, Clayton, CA (US); Giovanni A. Moro, San Francisco, CA (US); Michael J. Boggs, Folsom, CA (US); Ravi K. Maganti, Eden Prairie, MN (US)

(21) Appl. No.: 15/351,735

(22) Filed: Nov. 15, 2016

(51) Int. Cl. G06Q 50/16; G06Q 10/06

(52) U.S. Cl. CPC G06Q 50/163; G06Q 10/063114

(57) ABSTRACT

A home status system and method include receiving data regarding a house condition, storing the house condition data in a database and generating a user interface for displaying house information. The generated user interface displays a real-time status of predetermined areas of the house based on the house condition data. The data may be applied to predetermined rules to determine home projects that are displayed on the user interface.

### BACKGROUND

Owning a house can be very complicated and time consuming. To maximize appreciation of the house, or even just to prevent reduction in the resale value of the house, the home must be properly maintained. In order to maintain a home, it is typically necessary to monitor the status of various parts of the house, such as the structure (roof, siding, mechanical systems, etc.), decor, appliances, and the like. Additionally, to properly manage a house and increase its value, the home owner may need to select from among several maintenance and improvement projects. Available funds might not allow completing all desired projects. The process of selecting and prioritizing such projects may require gathering and analyzing information from several sources.

### SUMMARY

In accordance with certain aspects of the present disclosure, examples of various systems and computer implemented processes include receiving data regarding a house condition, storing the house condition data in a database and generating a user interface for displaying house information. For example, the generated user interface may display a real-time status of predetermined areas of the house based on the house condition data. Further, the house condition data may be applied to predetermined rules to identify home projects. The home projects are then displayed on the user interface. Data regarding the house may be received from various sources, such as from a home owner via the user interface, from an appraisal of the house, from smart devices in the house, from contractors or service providers working on the house, from financial institutions, from comparable houses, and the like.

### DESCRIPTION OF THE DRAWINGS

FIG. 1 is a block diagram illustrating an example of a house status and analysis system in accordance with aspects of the present disclosure.

FIG. 2 is block diagram illustrating examples of data sources a system such as that shown in FIG. 1.

FIG. 3 is a flow diagram illustrating an example of a house status and analysis process in accordance with aspects of the present disclosure.

FIG. 4 is a timeline illustrating examples of house projects and associated information sources in accordance with aspects of the present disclosure.

FIG. 5 illustrates an example of a portion of a user interface display in accordance with aspects of the present disclosure.

FIG. 6 illustrates another example of a portion of a user interface display in accordance with aspects of the present disclosure.

FIG. 7 is a block diagram illustrating portions of an example computer system.

### DETAILED DESCRIPTION

In the following Detailed Description, reference is made to the accompanying drawings, which form a part hereof, and in which is shown by way of illustration specific embodiments in which the invention may be practiced. The following detailed description, therefore, is not to be taken in a limiting sense.

Owning a house can be a complicated and expensive undertaking. Buying a home is often one of the biggest financial transactions in a person's life. Financial transactions associated with home buying such as home loans or home refinances are often complex, and providing financing to home buyers is also complicated and expensive for the financial institution originating the various home loans. Moreover, when a home is sold, the process may have to be repeated for the buyer, even if the same financial institution provides financing for both the current and previous home buyer. Among other things, this requires repeating the home appraisal and other steps in the loan process.

Once the home is purchased, it must be properly maintained to maintain the value of the property. In order to maintain a home, it is typically necessary to monitor the status of various parts of the house, such as the structure (roof, siding, mechanical systems, etc.), decor, appliances, and the like. Additionally, to properly manage a house and increase its value, the home owner may need to select from among several maintenance and improvement projects based on available funds, return on investment, severity of the projects, etc.

For some home owners, monitoring the status of their homes is difficult. For instance, it can be difficult to know when to replace a roof or siding. Keeping up with maintenance of mechanical systems such as heating systems is also daunting, and when a system fails it can be difficult to decide whether to repair or replace the failed system. Home improvement projects such as room additions or remodels are also complicated and expensive undertakings. It can be difficult to decide which projects provide the best return on the investment when the homeowner goes to sell the house, for example.

Some example systems and processes disclosed herein provide real time house information homeowner. Data from various sources is combined and analyzed, and applied to predetermined rules to generate a user interface that displays real time house information. Some examples provide information and recommendations regarding home projects, just as improvement or maintenance projects.

For example, data about house condition and status is gathered from various sources, such as information in inspection reports and appraisals. Appraisers may provide additional information about the house at the time of appraisal, such as amount of time left on a roof, when the last roof was installed, etc. Information may also be gathered from the owner of the house on an ongoing basis, either directly from the home owner or automatically from other sources such as internet enabled smart devices/appliances within the house. Information regarding updates to work done on the house may further be provided, such as new siding, updated kitchen or bathroom, etc.

Service providers can also provide information about improvements made to the house, and information regarding contractors may be maintained and provided to the homeowner. Analysis of such state may provide the home owner with ongoing information about the house, and generate recommendations for improvements to the house that would provide good return on investment. As discussed further herein, a user interface can show the status of repair of certain portions of the house, such as roof, siding, windows, etc. based on the information gathered.

Disclosed systems analyze the effect of home improvement projects on the home's value based on data related to comparable houses, and make recommendations, based on age and status of various portions of the house to recommend improvements that could be made to increase value, such kitchen remodel, bathroom remodel, new flooring, etc. Such recommendations may be generated to maximize the return on investment, for example, by identifying a recommended budget for the recommended projects.

By maintaining real time, ongoing status information regarding the house, future loans related to the house could be automatically preapproved, and may not require an appraisal when the house is later sold.

For example, data about house condition and status may be gathered from various sources, such as information in inspection reports and appraisals. Information may also be gathered from the owner of the house on an ongoing basis; either via responses collected from the owner or from internet connected smart devices/appliances within the house. Service providers, such as repair or maintenance contractors, can also provide information about improvements made to the house. The home owner can then be provided with real time, ongoing information about the house based on the gathered information. Further, the collected data may be analyzed and applied to rules to generate recommendations for improvements to the house that would provide good return on investment. In some implementations, the ongoing status information is further used to do an automatic loan preapproval of a house without an appraisal when the house is later sold.

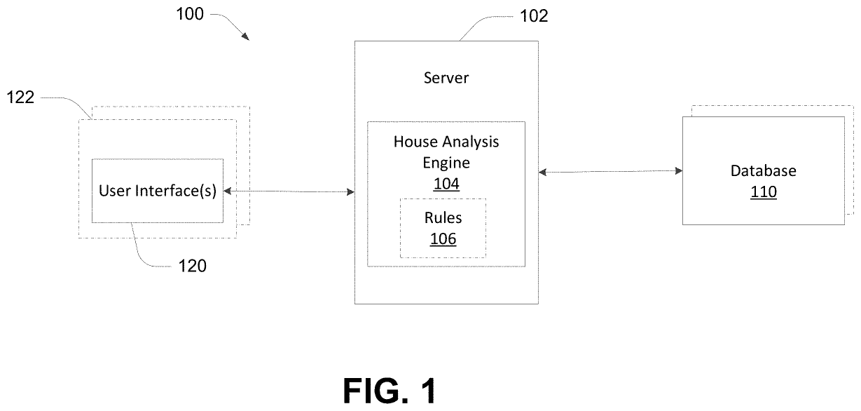

FIG. 1 is a block diagram illustrating an example system 100 that includes a computing system such as a computer 102 implementing a house analysis engine 104. In some examples, the computing system 102 is a server computer at a financial institution such as a bank, brokerage firm, mortgage company, etc. Other examples of financial institutions are possible. Further, the server 102 may be implemented by one or more computer systems. One or more databases 110 are accessible by the server 102. For example, the databases 110 may include one or more databases associated with the financial institution computer 102, storing information regarding internal customer accounts. Other databases 110 may include one or more external databases storing information external to the financial institution. Thus, the database 110 could be a local component of the server 102, though not necessarily located in close physical proximity to the server 102. For example, the database 110 could be accessible by the server 102 over local or wide area business networks or over other networks such as the internet.

In general, the computer 102 is operable to access the database 110 to obtain information regarding a particular house that has been saved in the database 110. One or more user interfaces 120 are configured to display and receive information from a home owner. For example, the user interface 120 may be configured to receive house information from a home owner, as well as display home information for the home owner. The user interface 120 could be implemented on a user computer 122, which could be any of a number of suitable devices such as a desktop computer, laptop computer, tablet device, smart phone, etc. that communicates with the server 102, for example, via a network such as the internet. The house analysis engine further includes a rules engine 106 implemented by the computer 102, that applies predetermined rules to the gathered data to generate house status information as well as improvement project information and recommendations.

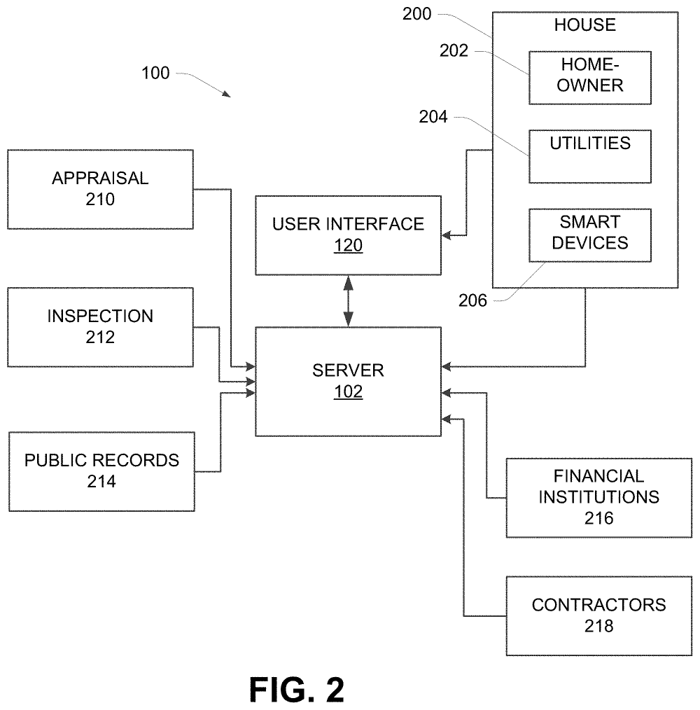

FIG. 2 is a block diagram illustrating examples of sources of data from which the computer 102 receives house information. As noted previously and shown in FIG. 1, the house analysis engine 104 generates the user interface 120 that may be displayed on a home owner's computer 122, such as a home desktop or laptop computer, tablet, smart phone, etc. Via the user interface 120, the homeowner 202 may provide information regarding his or her house 200. For example, information regarding purchases for decorating, maintaining, repairing, etc. could be provided by the home owner 202 through the user interface 120, which is then saved in the database 110. Additionally, information regarding utilities 204 may be received via the user interface 120, or this information could be directly received by the house analysis engine 104 of the computer 102 and saved in the database 110. For example, utility costs, power and water usage information, etc. could be automatically obtained from the home mechanical systems, smart thermostats and the like, and/or directly from the utility companies. Other internet connected smart devices 206 such as smart appliances may provide further home condition information to the computer 102 and saved to the database 110.

In some examples, application programming interfaces (API) are created to allow application developers for smart devices such as thermostats, home heating and cooling systems, smart appliances, etc. to connect with the home analysis engine 104 to directly provide information. Such APIs may also allow application developers for other information sources discussed further below to provide house information. Additional sources of house information may include, for example, appraisal information 210, home inspection information 212, public records information 214 such as various tax records, deed information, etc. Financial institutions 216 may provide information regarding various home loans and amounts spent for home improvements and maintenance. Further, in some implementations, information from contractors 216 providing repairs, maintenance, improvements, etc. is received. Still further, information from sources such as those shown in FIG. 2 relating to comparable homes is received and saved in some embodiments for further analysis.

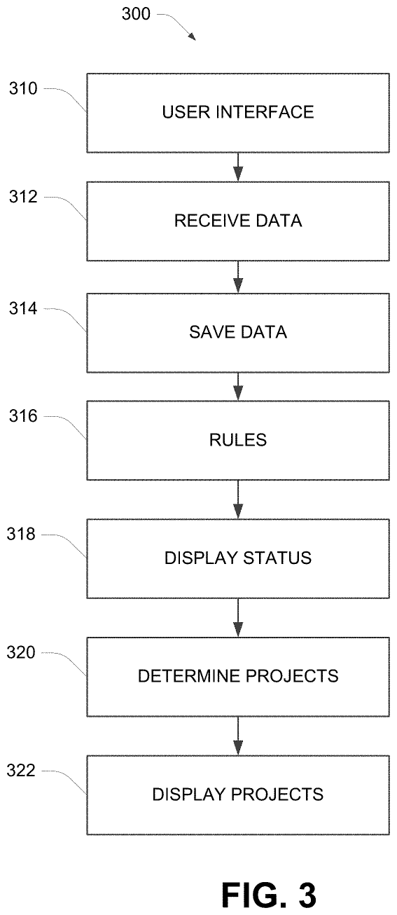

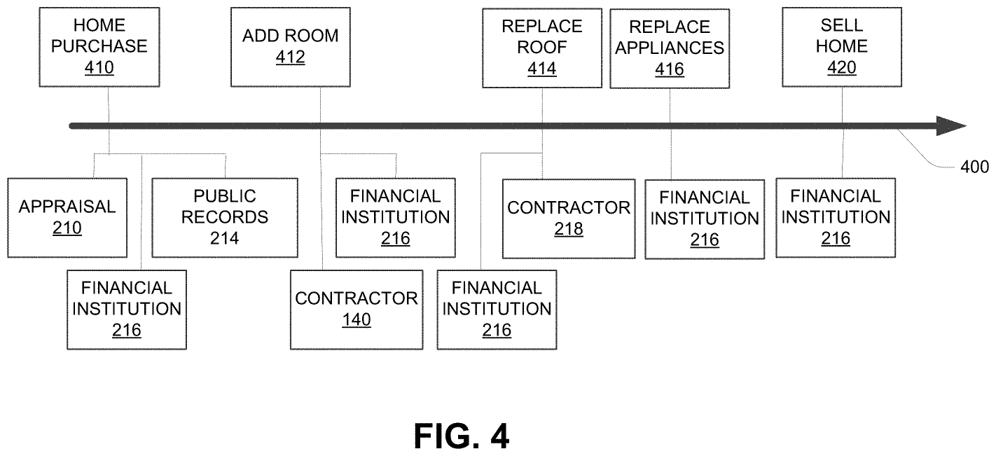

FIG. 3 is a flow diagram illustrating aspects of a method 300 executed by the home analysis engine 104 of the computer 102. In block 310 of FIG. 4, the computer 102 generates the user interface 120 as shown in FIGS. 1 and 2. In block 312, home information is received such as through the user interface and/or sources such as those shown in FIG. 2 and other sources. The data are saved, such as to the database 110, in block 314. Received data are applied to predetermined rules in block 316 by the rules engine 106 shown in FIG. 1. Among other things, rules are developed and stored for determining and monitoring the condition and status of the home, including a real time evaluation of the home's worth. Such home status may be displayed via the user interface as indicated in block 318. Further rules are applied in block 316 that determine and evaluate recommended home improvement projects in block 320. For example, the rules engine 106 may apply rules to data saved in the database 110 to determine recommended remodeling projects, home mechanical system maintenance/repair/replacement projects, appliance and furniture projects, etc. Such projects and associated information is displayed on the user interface in block 322.

FIG. 4 illustrates a timeline 400, with examples various events associated with a house shown above the timeline 400. As shown at the beginning (left end) of the timeline 400, the house is purchased 410. Examples of information sources from FIG. 2 associated with the house events are shown below the timeline 400. Of course, the information sources shown in FIGS. 2 and 4 are examples, and many other sources could provide home condition information that could be saved in the database 110 and applied to the rules engine 106. Referring again to the home purchase 410, information from the appraisal 210, public records 214 and financial institution(s) 216 is received and saved. Further information may be received from the home owner through the user interface 110.

As time progresses (left to right) on the timeline 400, additional information not necessarily related to specific events may further be received by the computer 102 and saved in the database 110 for application to the rules engine 106. For instance, data for comparable houses may be analyzed to provide recommendations to the home owner. Additionally, information regarding the typical life cycles of home systems may be received and saved. Applying such information to the rules engine 106 may result in providing and displaying on the user interface 120 a real time status of the home and various systems and items contained in the house. Moreover, receiving and saving such information allows the rules engine 106 to constantly update a real time value of the house.

As noted above, it can be difficult for a home owner to determine appropriate times for completing home improvement and maintenance projects. By providing a real time home status to the home owner, such decisions may be simplified. Further, by analyzing data relating to the house and comparable houses, the analysis engine 104 may provide recommendations for various home improvement projects. For example, as the home owner's family grows, he or she may desire to add on to the home. Based on data associated with projects completed on comparable homes, the analysis engine 104 generate and display information regarding costs of various types of additions, typical return on investment for such projects, recommendations for contractors, loan preapprovals, etc.

When a room addition project 412 is undertaken, data from sources such as contractors and service providers 140 completing the work, financial institutions 216 providing funds, etc. are received and stored. Such information is applied to the rules engine 106 to update the home status.

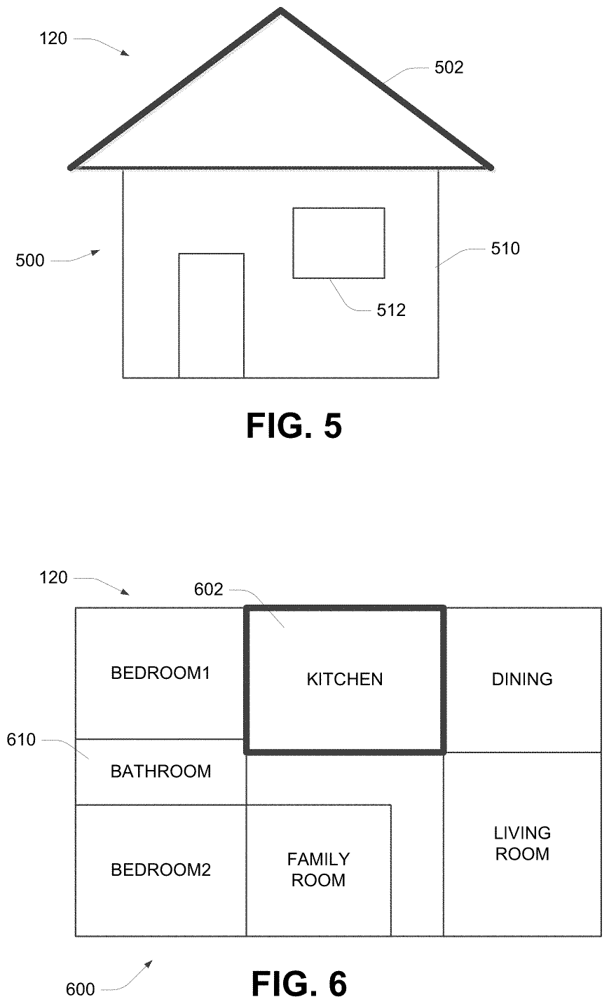

FIGS. 5 and 6 illustrate examples of portions of the user display 120. In some embodiments, the user interface 120 displays an image of the house. FIG. 5 shows a portion of the user interface 120, including an image 500 of an exterior of a house. In some examples, portions of the image of the house corresponding to home improvement projects are highlighted. In FIG. 5, the roof 502 is highlighted, indicating an area for recommended improvement projects. The user may then select the roof 502, in response to which information regarding the recommended home improvement project, such as replacing the roof, is displayed. Such displayed information could include, for example, estimated costs of the roof replacement, contractors for doing the work, sources for financing the project, including preapprovals for loans such as home equity loans. In some embodiments, the status can be shown with a red-yellow-green indicator for each of the selected home portions.

FIG. 4 shows a roof replacement project 414 on the timeline 400. Information from the contractor 218 and financial institution 216, among others, may be saved to the database 110 for application to the rules engine 106. In the process of planning and completing the roof replacement project 414, the computer 102 could further interface with other external agencies to obtain necessary permits and update insurance policies. Information associated with the project may further be used to update the real time status of the house, including a real time financial evaluation of the house to estimate the house's current resale value.

FIG. 6 illustrates another portion of an example user interface 120, providing an image of the house floorplan 600. As discussed in conjunction with FIG. 5, portions of the house for which home projects are recommended may be highlighted. In FIG. 6, the kitchen 602 is highlighted. By selecting the highlighted kitchen 602, information regarding projects associated with the kitchen is displayed. For example, in response to a selection of the kitchen 602 in the image displayed on the user interface 120, recommendations regarding appliance replacements may be displayed. Such information could include projected costs, ratings of various appliance models and manufacturers, sources for appliances, financing, etc.

An appliance replacement project 416 is shown on the timeline 400 of FIG. 4. Information from the financial institution 216, such as a credit card provider, may be saved to the database 110 for application to the rules engine 106. Additional information may further be saved and analyzed. The computer 102 could further automatically interface with other external agencies to provide warranty registrations, maintenance contracts, etc. for the new appliances. Information associated with the project may further be used to update the real time status of the house, including a real time financial evaluation of the house to estimate the house's current resale value.

Information regarding the real time status of various portions of the house may be obtained by selecting the desired areas. For example, in response to a user's selection of the exterior 510 of the house in FIG. 5, the status of the siding could be displayed. Selecting the window 512 would result in displaying information regarding the home's windows, such as make, model, value, age, etc. In response to a selection of the bathroom 610 shown in FIG. 6, status information such as water usage, flooring type, age of fixtures, etc. could be displayed for the home owner.

Referring back to FIG. 4, a home sale event 420 is shown on the timeline 400. Among others, information from financial institutions 216 may be received and saved. Since the status and value of the house has been maintained in real time during the time period represented by the timeline 400, the sale event 420 and associated buying process may be simplified, reducing costs for those involved. For example, since information regarding home improvement projects has been saved to the database 110, the value of the home is more easily determined, possibly eliminating the need for an appraisal at the sale event 420, and further simplifying other aspects of the financing process.

In some embodiments, the information collected and stored in the database 110 includes images of physical documents and digital documents such as XML documents. The physical and/or digital documents may include, for example, tax returns and related documents, permits, appraisals, deeds, etc. Among other things, storing such assembled information in the database 110 allows subsequent use of the data for future home and financial processes. For example, if information is assembled for a mortgage application and stored in the vault, much of the same information could later be used if the same homeowner refinances or applies for a home equity line of credit.

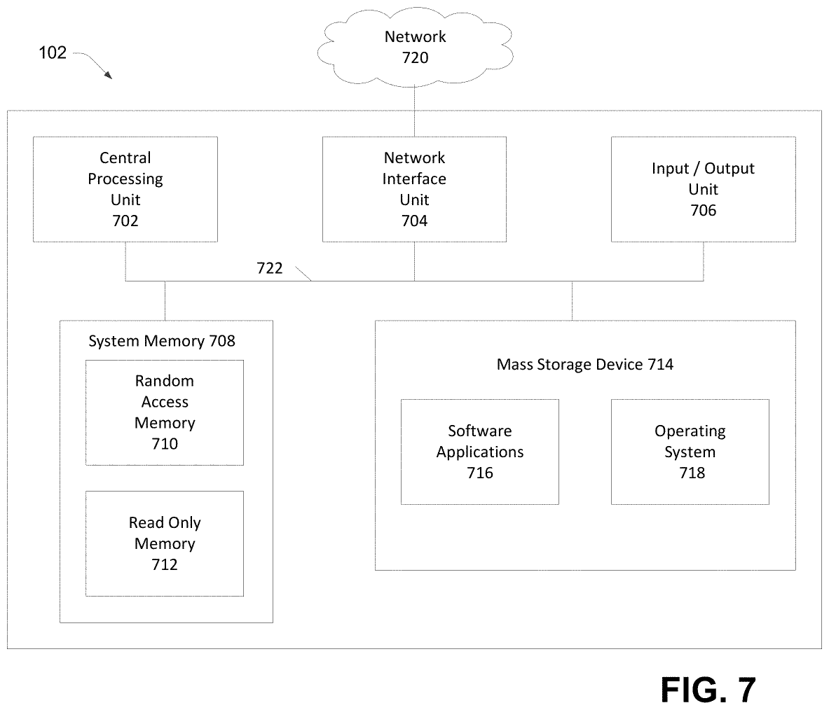

FIG. 7 schematically illustrates an example of the computer 102, which could be a server computer at a financial institution. The computer 102 includes at least one processor (“CPU”) 702, a system memory 708, and a system bus 722 that couples the system memory 708 to the CPU 702. The system memory 708 includes a random access memory (“RAM”) 710 and a read-only memory (“ROM”) 712. A basic input/output system that contains the basic routines that help to transfer information between elements within the server computer 102, such as during startup, is stored in the ROM 712. The server computer 102 further includes a mass storage device 714. The mass storage device 714 is able to store software instructions and data. As noted above, the database 110 could be implemented by the mass storage device 712, and could further include additional databases implemented by other computer systems accessible by the server 102. A processor, system memory and mass storage device similar to that in FIG. 7 are also included in each of the devices 122 providing the user interfaces 120.

The mass storage device 714 is connected to the CPU 702 through a mass storage controller (not shown) connected to the system bus 722. The mass storage device 714 and its associated computer-readable data storage media provide non-volatile, non-transitory storage for the server computer 102. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 102.

According to various embodiments of the invention, the server computer 102 may operate in a networked environment using logical connections to remote network devices through the network 720, such as a wireless network, the Internet, or another type of network. The server computer 102 may connect to the network 720 through a network interface unit 704 connected to the system bus 722. It should be appreciated that the network interface unit 704 may also be utilized to connect to other types of networks and remote computing systems. The server computer 102 also includes an input/output controller 706 for receiving and processing input from a number of other devices, including a touch user interface display screen, or another type of input device. Similarly, the input/output controller 706 may provide output to a touch user interface display screen or other type of output device.

As mentioned briefly above, the mass storage device 714 and the RAM 710 of the server computer 102 can store software instructions and data. The software instructions include an operating system 718 suitable for controlling the operation of the server computer 102. The mass storage device 714 and/or the RAM 710 also store software instructions, that when executed by the CPU 702, cause the server computer 102 to provide the functionality of the server computer 102 discussed in this document. For example, the mass storage device 714 and/or the RAM 710 can store software instructions that, when executed by the CPU 702, cause the server computer 102 to implement the house analysis engine 104 and the rules engine 106 shown in FIG. 1 for applying the various processes described herein, among other things.

Although various embodiments are described herein, those of ordinary skill in the art will understand that many modifications may be made thereto within the scope of the present disclosure. For instance, examples related to home loans are included herein, though the disclosed systems and methods are also applicable to many other financial processes, such as personal and business loans, credit card accounts, home equity lines of credit, mortgage refinances, etc. Accordingly, it is not intended that the scope of the disclosure in any way be limited by the examples provided.

1. A system, comprising:
a processor;
a memory accessible by the processor storing program instructions that configure the processor to:
receive data regarding a house condition;
store the house condition data in a database;
generate a user interface that displays two or more predetermined areas of the house, wherein the two or more predetermined areas of the house comprise:
a first area including an inside of the house, wherein the first area comprises a floor plan, with at least one room in the floor plan having a visual indicia that highlights the at least one room as having a recommendation associated with the at least one room, wherein the at least one room is selectable to view the recommendation; and
a second area including an exterior of the house;
receive a selection of one of the two or more predetermined areas of the house;
generate, in the user interface, and in response to the selection, a real time status of the selected area of the house;
apply the house condition data to predetermined rules to determine home projects for the selected area of the house;
display, on the user interface, and in response to the selection, information indicating a preapproval for a loan to finance one of the home projects associated with the selected one of the predetermined areas; and
display different ones of the home projects on the user interface at different times based on a real time status of the house at each of the different times,
wherein a recommended budget is generated for each of the home projects displayed; and
wherein the recommended budget and the home projects displayed are based on a maximization of a predicted return on investment for a future sale of the house.

2. The system of claim 1, wherein receiving the data regarding the house condition includes receiving data from a home owner via the user interface.

3. The system of claim 1, wherein receiving the data regarding the house condition includes receiving data from an appraisal of the house.

4. The system of claim 1, wherein receiving the data regarding the house condition includes receiving data from smart devices in the house.

5. The system of claim 1, wherein receiving the data regarding the house condition includes receiving data from service providers working on the house.

6. The system of claim 1, wherein receiving the data regarding the house condition includes receiving data from a financial institution.

7. The system of claim 1, wherein the program instructions further configure the processor to:
receive data regarding completed home projects completed on comparable houses; and
apply the completed home projects completed on comparable houses data to the predetermined rules to identify the displayed home projects.

8. The system of claim 1, wherein displaying the different ones of the home projects on the user interface includes displaying an image of the house.

9. The system of claim 8, wherein displaying the different ones of the home projects on the user interface includes highlighting portions of the image of the house in the second area indicating that an area of the house associated with the highlighted portion has a recommended home project for the area of the house and can be selected to view the home project.

10. The system of claim 9, wherein displaying the different ones of the home projects on the user interface includes displaying home projects corresponding to a selected highlighted portion of the image of the house.

11. The system of claim 1, wherein generating the real time status of the selected area of the house includes:
displaying an image of the house; and
displaying the real time status of a portion of the house corresponding to a selected portion of the image of the house or the floor plan of the house.

12-20. (canceled)
